(19) United States
(12) Patent Application Publication
(10) Pub. No.: US 2017/0221480 A1
(43) Pub. Date: Aug. 3, 2017

(54) SPEECH RECOGNITION SYSTEMS AND METHODS FOR AUTOMATED DRIVING

(71) Applicant: GM GLOBAL TECHNOLOGY OPERATIONS LLC, Detroit, MI (US)

(72) Inventors: ELI TZIRKEL-HANCOCK, RA'ANANA (IL); SCOTT D. CUSTER, WARREN, MI (US); DAVID P. POP, GARDEN CITY, MI (US); ILAN MALKA, TEL AVIV (IL)

(73) Assignee: GM GLOBAL TECHNOLOGY OPERATIONS LLC, Detroit, MI (US)

(21) Appl. No.: 15/011,060

(22) Filed: Jan. 29, 2016

(51) Int. Cl. G10L 15/22; G05D 1/00; B60W 50/10; G10L 15/18

(52) U.S. Cl. CPC G10L 15/22; G10L 15/1815; G05D 1/0088; B60W 50/10; G10L 2015/223; G10L 2015/228; B60W 2540/02

(57) ABSTRACT

Methods and systems are provided for processing speech for a vehicle having at least one autonomous vehicle system. In one embodiment, a method includes: receiving, by a processor, context data generated by an autonomous vehicle system; receiving, by a processor, a speech utterance from a user interacting with the vehicle; processing, by a processor, the speech utterance based on the context data; and selectively communicating, by a processor, at least one of a dialog prompt to the user and a control action to the autonomous vehicle system based on the context data.

### TECHNICAL FIELD

The technical field generally relates to speech systems, and more particularly relates to speech methods and systems for use in automated driving of a vehicle.

### BACKGROUND

Vehicle speech systems perform speech recognition on speech uttered by an occupant of the vehicle. The speech utterances typically include queries or commands directed to one or more features of the vehicle or other systems accessible by the vehicle.

An autonomous vehicle is a vehicle that is capable of sensing its environment and navigating with little or no user input. An autonomous vehicle senses its environment using sensing devices such as radar, lidar, image sensors, etc. and/or using information from systems such as global positioning systems (GPS), other vehicles, or other infrastructure.

In some instances, it is desirable for a user to interact with the autonomous vehicle while the vehicle is operating in an autonomous mode or partial autonomous mode. If the user has to physically interact with one or more buttons, switches, pedals or the steering wheel, then the operation of the vehicle is no longer autonomous. Accordingly, it is desirable to use the vehicle speech system to interact with the vehicle while the vehicle is operating in an autonomous or partial autonomous mode such that information can be obtained from speech or the vehicle can be controlled by speech. It is further desirable to provide improved speech systems and methods for operating with an autonomous vehicle. Furthermore, other desirable features and characteristics of the present invention will become apparent from the subsequent detailed description and the appended claims, taken in conjunction with the accompanying drawings and the foregoing technical field and background.

### SUMMARY

Methods and systems are provided for processing speech for a vehicle having at least one autonomous vehicle system. In one embodiment, a method includes: receiving, by a processor, context data generated by an autonomous vehicle system; receiving, by a processor, a speech utterance from a user interacting with the vehicle; processing, by a processor, the speech utterance based on the context data; and selectively communicating, by a processor, at least one of a dialog prompt to the user and a control action to the autonomous vehicle system based on the context data.

In one embodiment, a system includes a first module that a first non-transitory module that receives, by a processor, context data generated by an autonomous vehicle system. The system further includes a second non-transitory module that receives, by a processor, a speech utterance from a user interacting with the vehicle. The system further includes a third non-transitory module that processes, by a processor, the speech utterance based on the context data. The system further includes a fourth non-transitory module that selectively communicates, by a processor, at least one of a dialog prompt to the user and a control action to the autonomous vehicle system based on the context data.

### DESCRIPTION OF THE DRAWINGS

The exemplary embodiments will hereinafter be described in conjunction with the following drawing figures, wherein like numerals denote like elements, and wherein:

FIG. 1 is a functional block diagram of an autonomous vehicle that is associated with a speech system in accordance with various exemplary embodiments;

FIG. 2 is a functional block diagram of the speech system of FIG. 1 in accordance with various exemplary embodiments; and

FIGS. 3 through 5 are flowcharts illustrating speech methods that may be performed by the vehicle and the speech system in accordance with various exemplary embodiments.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. As used herein, the term module refers to an application specific integrated circuit (ASIC), an electronic circuit, a processor (shared, dedicated, or group) and memory that executes one or more software or firmware programs, a combinational logic circuit, and/or other suitable components that provide the described functionality.

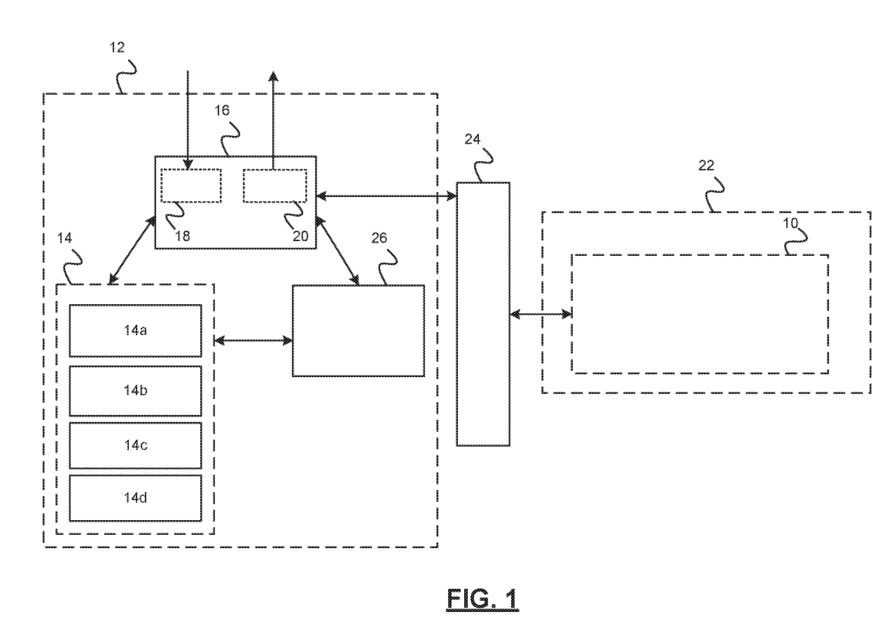

With initial reference to FIG. 1, in accordance with exemplary embodiments of the present disclosure, a speech system 10 is shown to be associated with a vehicle 12. The vehicle 12 includes one or more autonomous vehicle systems, generally referred to as 14. The autonomous vehicle systems 14 include one or more sensors that sense an element of an environment of the vehicle 12 or that receive information from other vehicles or vehicle infrastructure and control one or more functions of the vehicle 12 to fully or partially aid the driver in driving the vehicle 12. When the vehicle is an automobile, the autonomous vehicle systems 14 can include, but are not limited to, a park assist system 14a, a vehicle cruise system 14b, a lane change system 14c, and a vehicle steering system 14d.

The vehicle 12 further includes a human machine interface (HMI) module 16. The HMI module 16 includes one or more input devices 18 and one or more output devices 20 for receiving information from and providing information to a user. The input devices 18 include, at a minimum, a microphone or other sensing device for capturing speech utterances by a user. The output devices 20 include, at a minimum, an audio device for playing a dialog back to a user.

As shown, the speech system 10 is included on a server 22 or other computing device. In various embodiments, the server 22 and the speech system 10 may be located remote from the vehicle 12 (as shown). In various other embodiments, the speech system 10 and the server 22 may be located partially on the vehicle 12 and partially remote from the vehicle 12 (not shown). In various other embodiments, the speech system 10 and the server 22 may be located solely on the vehicle 12 (not shown).

The speech system 10 provides speech recognition and a dialog for one or more systems of the vehicle 12 through the HMI module 16. The speech system 10 communicates with the HMI module 16 through a defined application program interface (API) 24. The speech system 10 provides the speech recognition and the dialog based on a context provided by the vehicle 12. Context data is provided by the autonomous vehicle systems 14; and the context is determined from the context data.

In various embodiments, the vehicle 12 includes a context manager module 26 that communicates with the autonomous vehicle systems 14 to capture the context data. The context data indicates a current automation mode and a general state or condition associated with the autonomous vehicle system 14 and/or an event that has just occurred or is about to occur based on the control of the autonomous vehicle system 14. For example, the context data can indicate a position of another vehicle (not shown) relative to the vehicle 12, a geographic location of the vehicle 12, a position of the vehicle 12 on the road and/or within a lane, a speed or acceleration of the vehicle 12, a steering position or maneuver of the vehicle 12, a current or upcoming weather condition, navigation steps of a current route, etc. In another example, the context data can indicate an event that has occurred or that is about to occur. The event can include an alarm or warning signal that was generated or is about to be generated, a change in vehicle speed, a turn has been or is about to be made, a lane change has been or is about to be made, etc. As can be appreciated, these examples of context data and events are merely some examples, as the list may be exhaustive. The disclosure is not limited to the present examples. In various embodiments, the context manager module 26 captures context data over a period of time, in which case, the context data includes a timestamp or sequence number associated with the state, condition, or event.

In various embodiments, the context manager module 26 processes the received context data to determine a current automation mode and grammar options, intent options, and dialog content that is associated with the current automation mode. For example, the context manager module 26 stores a plurality of grammar options, intent options, and dialog content and their associations with particular automation modes and context data; and the context manager module 26 selects certain grammar options, intent options, and dialog content based on the current automation mode, the current context data, and the associations. The context manager module 26 then communicates the current automation mode and the selected grammar options, intent options, and dialog content as metadata to the speech system 10 through the HMI module 16 using the defined API 24. In such embodiments, the speech system 10 processes the options provided in the metadata to determine a grammar, an intent, and a dialog to use in the speech processing.

In various other embodiments, the context manager module 26 communicates the context data or indexes or other value indicating the context data directly to the speech system 10 through the HMI module 16 using the defined API 24. In such embodiments, the speech system 10 processes the received actual data or indexes directly to determine a grammar, an intent, and a dialog to use in the speech processing.

Upon completion of the speech processing by the speech system 10, the speech system 10 provides a dialog prompt, an index of a prompt, an action, an index of an action or any combination thereof back to the vehicle 12 through the HMI module 16. The dialog prompt, index, or action is then further processed by, for example, the HMI module 16 to deliver the prompt to the user. If a task is associated with the prompt, the task is delivered to the autonomous vehicle system 14 that is controlling the current automation mode, to complete the action based on the current vehicle conditions.

The speech system 10 is therefor configured to provide speech recognition, dialog, and vehicle control for the following exemplary use cases.

Use Case 1 includes user communications for partially autonomous vehicle functions such as: “Safe to overtake now?”, “Can I park here?” with system response to the user communications such as: “Overtake as soon as you can,” “Keep a larger distance (from a car in front)”, “Ask me before changing lanes”, or “Follow the car in front.”

Use Case 2 includes user communications for autonomous vehicle functions such as: “change lane,” “move to the left lane,” “right lane,” or “keep a larger distance.”, with a system response to the user communications such as, the vehicle moving to the right lane, the vehicle slowing down to keep a distance from a car in front, the vehicle speeding up to keep a larger distance from a car in the rear, or a question by the system to “move to the left or right lane?”.

Use Case 3 includes user communications for making a query following an event indicated by sound, light, haptic, etc. such as: “What is this sound?”, “What's that light?”, “Why did my seat vibrate?”, or “What's that?”, with a system response to the user communications such as, “the sound is a warning indicator for a vehicle in the left lane,” “your seat vibrated to notify you of the next left turn,” or “that was a warning that the vehicle is too close.”

Use Case 4 includes user communications for making a query following a vehicle event such as: “Why are you slowing down?”, “Why did you stop?”, or “What are you doing?”, with a system response such as “the vehicle in front is too close,” “we are about to make a left turn,” or “the upcoming traffic signal is yellow.”

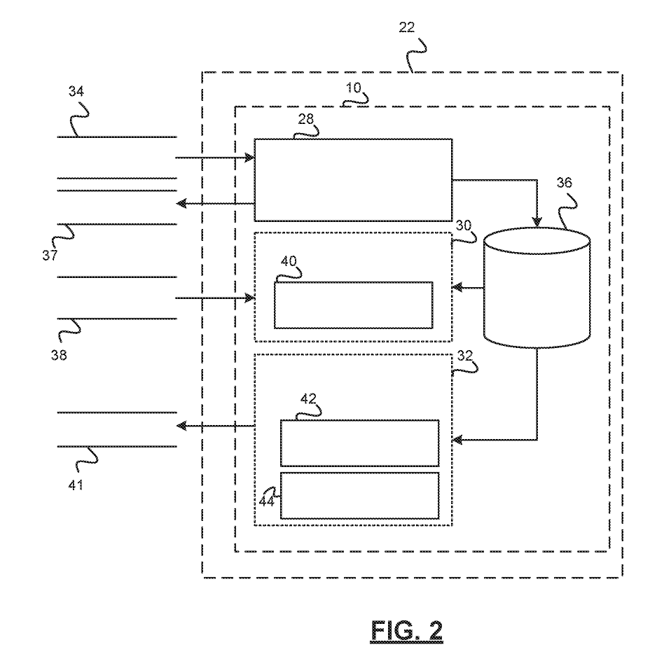

Referring now to FIG. 2 and with continued reference to FIG. 1, the speech system 10 is shown in more detail in accordance with various embodiments. The speech system 10 generally includes a context manager module 28, an automatic speech recognition (ASR) module 30, and a dialog manager module 32. As can be appreciated, the context manager module 28, the ASR module 30, and the dialog manager module 32 may be implemented as separate systems and/or as one or more combined systems.

The context manager module 28 receives context data 34 from the vehicle 12. As discussed above, the context data 34 can include the current automation mode, and actual data, indexes indicating the actual data, or the metadata including the grammar options, intent options, and dialog content that is associated with the current automation mode. The context manager module 28 selectively sets a context of the speech processing by storing the context data 34 in a context data datastore 36. The stored context data 34 may then be used by the ASR module 30 and/or the dialog manager module 32 for speech processing. The context manager module 28 communicates a confirmation 37, indicating that the context has been set, back to the vehicle 12 through the HMI module 16 using the defined API 24.

During operation, the ASR module 30 receives speech utterances 38 from a user through the HMI module 16. The ASR module 30 generally processes the speech utterances 38 using one or more speech processing models and a determined grammar to produce one or more results.

In various embodiments, the ASR module 30 includes a dynamic grammar generator 40 that selects the grammar based on the context data 34 stored in the context data datastore 36. For example, in various embodiments, the context data datastore 36 may store a plurality of grammar options or classifiers and their association with automation modes and context data. When the context data 34 includes the actual data or indexes from the autonomous vehicle system 14, the dynamic grammar generator 40 selects an appropriate grammar from the stored grammar options or classifiers based on the current automation mode, and the actual data or indexes. In another example, when the context data 34 includes the metadata, the dynamic grammar generator 40 selects an appropriate grammar from the provided grammar options based on the current automation mode and optionally results from the speech recognition process.

The dialog manager module 32 receives the recognized results from the ASR module 30. The dialog manager module 32 determines a dialog prompt 41 based on the recognized results. The dialog manager module 32 determines the dialog prompt 41 based on the recognized results, a determined intent of the user, and a determined dialog. The determined intent and the determined dialog are dynamically determined based on the stored context data 34. The dialog manager module 32 communicates the dialog prompt 41 back to the vehicle 12 through the HMI module 16.

In various embodiments, the dialog manager module 32 includes a dynamic intent classifier 42 and a dynamic dialog generator 44. The dynamic intent classifier 42 determines the intent of the user based on the context data 34 stored in the context data datastore 36. For example, the dynamic intent classifier 42 processes the context data 34 stored in the context data datastore 36 and, optionally, the recognized results to determine the intent of the user. For example, in various embodiments, the context data datastore 36 may store a plurality of intent options or classifiers and their associations with automation modes and context data. When the context data 34 includes the actual data or indexes from the autonomous vehicle system 14, the dynamic intent classifier 42 selects an appropriate intent option or classifier from the stored intent options or classifiers based on the current automation mode, the recognized results, and the actual data or indexes. In another example, when the context data 34 includes the metadata, the dynamic intent classifier 42 selects an appropriate intent from the provided intent options based on the current automation mode and the recognized results.

The dynamic dialog generator 44 determines the dialog to be used in processing the recognized results. The dynamic dialog generator 44 processes the context data 34 stored in the context data datastore 36 and optionally, the recognized results along with the intent, to determine the dialog. For example, in various embodiments, the context data datastore 36 may store a plurality of dialog options or classifiers and their associations with automation modes and context data. When the context data 34 includes the actual data or indexes from the autonomous vehicle system 14, the dynamic dialog generator 44 selects an appropriate dialog option or classifier from the stored dialog options or classifiers based on the current automation mode, the actual data or indexes, and optionally, the intent and/or the recognized results. In another example, when the context data 34 includes the metadata, the dynamic dialog generator 44 selects an appropriate dialog from the provided dialog options based on the current automation mode, and optionally the intent, and/or the recognized results.

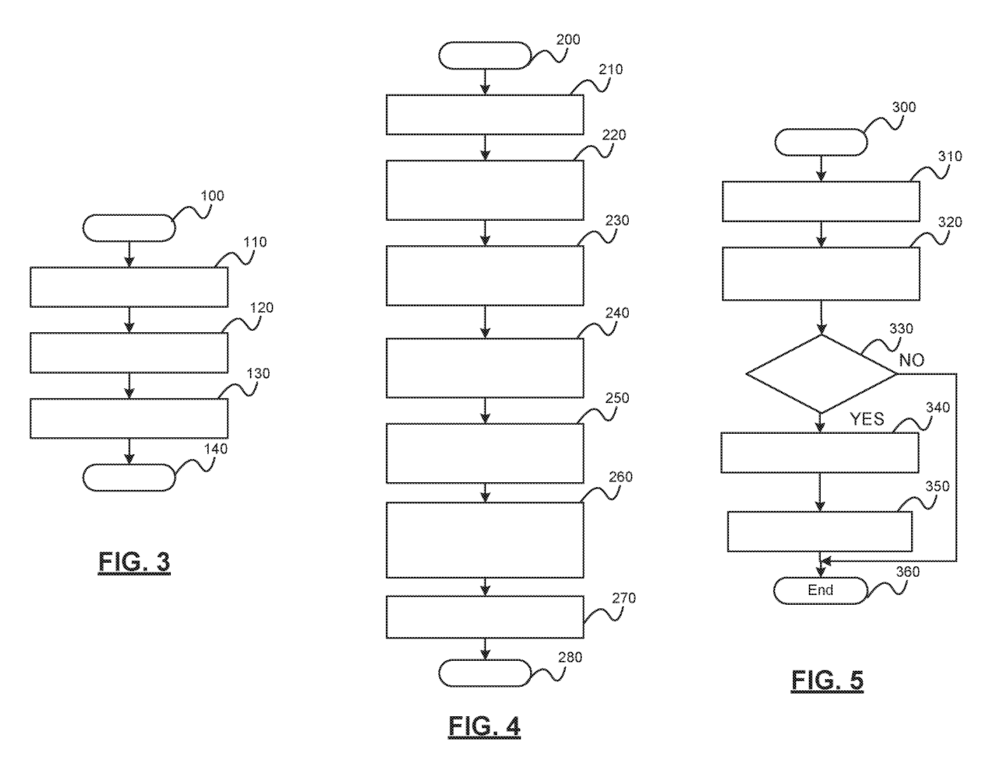

Referring now to FIGS. 3-5 and with continued reference to FIGS. 1-2, flowcharts illustrate speech methods that may be performed by the speech system 10 and/or the vehicle 12 in accordance with various exemplary embodiments. As can be appreciated in light of the disclosure, the order of operation within the methods is not limited to the sequential execution as illustrated in FIGS. 3-5, but may be performed in one or more varying orders as applicable and in accordance with the present disclosure. As can further be appreciated, one or more steps of the methods may be added or removed without altering the spirit of the method.

With reference to FIG. 3, a flowchart illustrates an exemplary method that may be performed to update the speech system 10 with the context data 34. The context data 34 is generated by an autonomous vehicle system 14. As can be appreciated, the method may be scheduled to run at predetermined time intervals or scheduled to run based on an event.

In various embodiments, the method may begin at 100. The context data 34 is received from the context manager module 26 at 110 from, for example, the HMI module 16. The context data 34 is stored in the context data datastore 36 at 120. The confirmation 37 is generated and communicated back to the vehicle 12 and, optionally the autonomous vehicle system 14 generating the context data 34, through the HMI module 16 at 130. Thereafter, the method may end at 140.

With reference to FIG.4, a flowchart illustrates an exemplary method that may be performed to process speech utterances 38 by the speech system 10 using the stored context data 34. The speech utterances 38 are communicated by the HMI module 16 during an automation mode of an autonomous vehicle system 14. As can be appreciated, the method may be scheduled to run at predetermined time intervals or scheduled to run based on an event (e.g., an event created by a user speaking).

In various embodiments, the method may begin at 200. The speech utterance 38 is received at 210. The context based grammar is determined from the context data 34 stored in the context data datastore 36 at 220. The speech utterance 38 is processed based on the context based grammar at 240 to determine one or more recognized results at 230.

Thereafter, the intent is determined from the context data 34 stored in the context data datastore 36 (and optionally based on the recognized results) at 240. The dialog is then determined from the context data datastore 36 (and optionally based on the intent and the recognized results) at 250. The dialog and the recognized results are then processed to determine the dialog prompt 41 at 260. The dialog prompt 41 is then generated and communicated back to the vehicle 12 through the HMI module 16 at 270. Thereafter, the method may end at 280.

With reference to FIG. 5, a flowchart illustrates an exemplary method that may be performed by the HMI module 16 to process the dialog prompt 41 received from the speech system 10. As can be appreciated, the method may be scheduled to run at predetermined time intervals or scheduled to run based on an event.

In various embodiments, the method may begin at 300. The dialog prompt 41 is received at 310. The dialog prompt 310 is communicated to the user via the HMI module 16 at 320. If the prompt is associated with a vehicle action (e.g., turn left, change lanes, etc.) at 330, the action is communicated to the autonomous vehicle system 14 at 340 and the autonomous vehicle system 14 selectively controls the vehicle 12 such that the action occurs 350. Thereafter, the method may end at 360.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method of processing speech for a vehicle having at least one autonomous vehicle system, comprising:
receiving, by a processor, context data generated by an autonomous vehicle system;
receiving, by a processor, a speech utterance from a user interacting with the vehicle;
processing, by a processor, the speech utterance based on the context data; and
selectively generating, by a processor, at least one of a dialog prompt to the user and a control action to the autonomous vehicle system based on the context data.

2. The method of claim 1, wherein the context data includes an automation mode of the autonomous vehicle system.

3. The method of claim 1, wherein the context data includes at least one of a state and a condition associated with the autonomous vehicle system.

4. The method of claim 1, wherein the context data includes an event that at least one of has just occurred and is about to occur based on control of the autonomous vehicle system.

5. The method of claim 1, further comprising processing the context data to determine at least one of grammar options, intent options, and dialog options, and wherein the processing the speech utterance is based on at least one of the grammar options, the intent options, and the dialog options.

6. The method of claim 1, further comprising processing the context data to determine an intent of the user, and wherein the selectively communicating the dialog prompt is based on the intent of the user.

7. The method of claim 1, further comprising processing the context data to determine a dialog, and wherein the selectively communicating the dialog prompt is based on the dialog.

8. The method of claim 1, further comprising processing the context data to determine a grammar, and wherein the processing the speech utterance is based on the grammar.

9. The method of claim 1, further comprising determining a grammar associated with the context data, determining an intent associated with the context data, and determining a dialog associated with the context data, and wherein the selectively communicating the dialog prompt is based on the grammar, the intent, and the dialog.

10. A system for processing speech of a vehicle having at least one autonomous vehicle system, comprising:
a first non-transitory module that receives, by a processor, context data generated by an autonomous vehicle system;
a second non-transitory module that receives, by a processor, a speech utterance from a user interacting with the vehicle;
a third non-transitory module that processes, by a processor, the speech utterance based on the context data; and
a fourth non-transitory module that selectively communicates, by a processor, at least one of a dialog prompt to the user and a control action to the autonomous vehicle system based on the context data.

11. The system of claim 10, wherein the context data includes an automation mode of the autonomous vehicle system.

12. The system of claim 10, wherein the context data includes at least one of a state and a condition associated with the autonomous vehicle system.

13. The system of claim 10, wherein the context data includes an event that at least one of has just occurred and is about to occur based on control of the autonomous vehicle system.

14. The system of claim 10, further comprising a fifth non-transitory module that processes, by a processor, the context data to determine at least one of grammar options, intent options, and dialog options, and wherein the third non-transitory module processes the speech utterance based on at least one of the grammar options, the intent options, and the dialog options.

15. The system of claim 10, further comprising a fifth non-transitory module that processes, by a processor, the context data to determine an intent of the user, and wherein the fourth non-transitory module selectively communicates the dialog prompt based on the intent of the user.

16. The system of claim 10, further comprising a fifth non-transitory module that processes, by a processor, the context data to determine a dialog, and wherein the fourth non-transitory module selectively communicates the dialog prompt based on the dialog.

17. The system of claim 10, further comprising a fifth non-transitory module that processes, by a processor, the context data to determine a grammar, and wherein the third non-transitory module processes the speech utterance based on the grammar.

18. The system of claim 10, further comprising a fifth non-transitory module that determines a grammar associated with the context data, that determines an intent associated with the context data, and that determines a dialog associated with the context data, and wherein the fourth non-transitory module selectively communicates the dialog prompt based on the grammar, the intent, and the dialog.

19. A vehicle, comprising:
at least one autonomous vehicle system;
a context manager module that captures context data from the at least on autonomous vehicle system; and
an automated speech system that receives the context data from the context manager module and that processes the context data with a speech utterance to selectively generate a dialog.

20. The vehicle of claim 19, wherein the context data includes an automation mode of the autonomous vehicle system.

21. The vehicle of claim 19, wherein the context data includes at least one of a state and a condition associated with the autonomous vehicle system, or an event that at least one of has just occurred and is about to occur based on the control of the autonomous vehicle system.
